(19) United States
(12) Patent Application Publication
(10) Pub. No.: US 2003/0072970 A1
(43) Pub. Date: Apr. 17, 2003

(54) Layered structure for magnetic recording heads

(75) Inventors: Yun-Fei Li, Fremont, CA (US); Hui-Chuan Wang, Pleasanton, CA (US); Chyu-Jiuh Torng, Pleasanton, CA (US)

Correspondence Address: GEORGE O. SAILE & ASSOCIATES, 28 DAVIS AVENUE, POUGHKEEPSIE, NY, 12603, US

(73) Assignee: Headway Technologies, Inc.

(21) Appl. No.: 09/971,284

(22) Filed: Oct. 5, 2001

(51) Int. Cl. B32B 9/00

(52) U.S. Cl. 428/694 EC; 428/694 MM; 428/694 R

(57) ABSTRACT

In magnetic recording applications, the continuing reduction of transducer dimensions has created a need for soft magnetic thin films with magnetic moments greater than about 22 kG are required. The present invention achieves this by use of a laminated structure made up of a thin layer of a high magnetic moment material on a layer of soft magnetic or non-magnetic material, both layers having very similar crystal structures and chemical composition, the main difference being in their nitrogen content. Such a laminate has been found to have the required high magnetic moment as well as low coercivity. The laminate is used to improve the characteristics and performance of a write head by being inserted at one or both sides of the write gap. Alternatively, the magnetic poles of the head may be constructed entirely from multiple instances of the laminate. A process for forming the laminate and applying it to the write head is also described.

### FIELD OF THE INVENTION

The invention relates to the general field of magnetic disks with particular reference to the recording head.

### BACKGROUND OF THE INVENTION

In magnetic recording applications, due to the continuing reduction of the transducer size, new soft magnetic thin films with magnetic moments greater than about 22 kG are required. The prior art has focused on Iron Nitride with some addition of third elements like aluminum and tantalum. Co₅₇Ni₁₃Fe₃₀ is another material system that has attracted a lot of attention. These materials can be made magnetically soft, but their magnetic moments are in the range of 18 to 22 kG. Materials with higher magnetic moment are needed.

It is known that bulk Niₓ(Fe_{100-y}Co_{y})₁₀₀₋ₓ, (x<10, 20<y<65) has a saturation magnetic moment higher than 22 kG together with low coercivity. However, their electrical resistance is low and their corrosion resistance is poor, which make them unsuitable for recording head applications. Thus there continues to be a need for materials that are magnetically soft, have high magnetic moment, and relatively high electrical resistivity.

FIG. 1 is a schematic view of a typical write head showing lower and upper magnetic poles 11 and 12 respectively. The magnetic flux generated by coil 16 (with 13 representing a single turn thereof) crosses between the poles at gap 14, there being sufficient fringing field to write on magnetic medium 15. FIG. 2 is a closeup of the head. Substrate 10 is a schematic representation of the remainder of the device which, typically, includes a giant magnetoresistance (GMR) read head.

A routine search of the prior art was performed with the following references of interest being found:

U.S. Pat. No. 6,178,070(Hong et al.) discloses a FeXN magnetic material 114 on the write gap material 112.

U.S. Pat. No. 6,111,729(Kamiguchi et al.) shows a FeXN as a diffusion barrier.

U.S. Pat. No. 6,087,026 (Kakehi et al.) and U.S. Pat. No. 6,023,353 (Ori) are related patents using FeXN materials.

S. X. Wang et al. “Properties of a new soft magnetic material” Nature 407 pp.150-151 September 2000.

W. P. Jaysekara et al. “Sandwich films” IEEE Trans. Magnetics vol. 35 no. 2 pp. 613-618 March 1999 [PLEASE PROVIDE COPY OF THE FULL PAPER]

### SUMMARY OF THE INVENTION

It has been an object of the present invention to provide a magnetic write head for a magnetic disk system.

Another object has been that said write head have magnetic poles made of materials that are magnetically soft, have high magnetic moment, and relatively high electrical resistivity.

A further object has been that said magnetic moment be greater than 22 kG

Still another object has been to provide a process for manufacturing said write head.

These objects have been achieved by the development of a laminated structure made up of a high moment material deposited on a thin layer of a non-magnetic material or on a layer of a soft magnetic material, both layers having very similar crystal structures and chemical composition, the main difference being in their nitrogen content. Such a laminate has been found to have the required high magnetic moment and low coercivity outlined above. The laminate is used to improve the characteristics and performance of a write head by being inserted adjacent to the write gap. Alternatively, the magnetic poles of the head may be constructed entirely from multiple instances of the laminate. A process for forming the laminate and applying it to the write head is also described.

### BRIEF DESCRIPTION OF THE DRAWINGS

FIG. 1 is a schematic view of a typical magnetic write head, including the coil and receiving medium.

FIG. 2 is a closeup of the upper and lower poles and write gap of the device shown in FIG. 1.

FIGS. 3 through 6 show four embodiments of the invention in which a laminate of a high moment layer on a non-magnetic or soft magnetic seed layer are located at various interfaces within the structure shown in FIG. 2.

FIG. 7 is a fifth embodiment of the invention in which the magnetic poles are formed from a plurality of said laminates.

### DESCRIPTION OF THE PREFERRED EMBODIMENTS

In the present invention, several different approaches are combined to solve the problem of achieving materials that are magnetically soft, while also having high magnetic moment and relatively high electrical resistivity. Targets of suitable materials known to have high magnetic moment (above 22 kG) were prepared. Additionally, nitrogen, hydrogen and/or oxygen could be incorporated in the films during deposition as a means to improve their magnetic softness and to increase their electrical resistivity. It was also found that further improvement could be made if another layer, either magnetically soft or non-magnetic was deposited either below, as the seed layer, or on top, as a capping layer.

This approach was based on the following insights:

a. Magnetic softness of a hard layer can be improved by laminating it with a softer magnetic seed layer or with a non-magnetic seed layer.

b. Lattice mismatch between substrate and the thin film on top can be significantly reduced by inserting a seed layer that matches the crystal lattice of the subsequent layers. It helps to reduce the stress-induced coercivity.

Therefore, the material for the seed layer and capping layer for our structure has been selected to be either one of the following candidates:

a. Soft magnetic materials including FeXY (X here refers to Al, Ti, Cr, Ta, Mo, Rh. Y is Nitrogen and/or Oxygen). They tend to have a relatively high saturation magnetization (18 to 22 kG) and are magnetically soft. Furthermore, they have good lattice match with Niₓ(Fe_{100-y}Co_{y})₁₀₀₋ₓ above, which helps to reduce the coercivity and anisotropy of the film further, without losing much of the total magnetization.

b. Non magnetic materials including FeXY (same as above) and Niₓ(Fe_{100-y}Co_{y})₁₀₀₋ₓY (x<10, 20<y<65) (Y is the same as in (a) above). Under high Y content, the above materials become non-magnetic. But lattice match with Niₓ(Fe_{100-y}Co_{y})₁₀₀₋ₓ still exists. Also at high Y concentration the grain size of the seed and/or capping layer is significantly reduced, which promotes small grain size growth in subsequent layers. All these factors thus help to reduce the coercivity of the total structure. Furthermore, such layers with high nitrogen content have much higher electrical resistivity and are essentially insulators. Therefore when inserted next to the write gap, such insulators can be simply regarded as an integral part of the gap layer.

c. To further extend this ideas, such sandwiched structures can be further laminated together, resulting in even higher saturation magnetization, lower coercivity and anisotropy, and higher electrical resistance.

Another available choice is the selection of a high nitrogen content non-magnetic layer deposited from the same target. This choice has some obvious advantages. First of all, when this thin seed layer is grown on top of write gap, due to its insulating behavior, it can be regarded as part of the write gap, which means no magnetic moment sacrifice on the subsequent FeCoN layer.

In addition, the insertion of such high nitrogen content layers can help us to increase the total resistance, as shown in TABLE I below, which helps to reduce eddy current induced write flux loss at high frequencies. This is especially important for the lamination case. Due to its insulating nature, such lamination can help to maintain or even increase the total resistance of the final structure.

Thicker films tend to worsen the magnetic properties. Our current results demonstrate feasibility for up to a 2000 Å thick film, which simplifies the process for seed layer growth. For the case of laminated films, this implies fewer laminations—which improves the fabrication efficiency and reduces fabrication costs.

TABLE I

| | | thick- | | | | p (ohm- |
|---|---|---|---|---|---|---|
| composition | type | ness | Bₛ (kG) | H_{c} (Oe) | Hₖ (Oe) | cm) |
| Fe₇₅Co₂₅N | magnetic | 2,000Å | 23 | 35 | 140 | 30 |
| Fe₇₅Co₂₅N | non-mag. | 50Å | 23 | 16 | 80 | 35 |
| Fe₇₅Co₂₅N | magnetic | 2,000Å | | | | |
| Fe₆₅Co₃₅N | magnetic | 2,000Å | 24 | 50 | 180 | — |
| Fe₆₅Co₃₅N | non-mag. | 50Å | 24 | 30 | 130 | — |
| Fe₆₅Co₃₅N | magnetic | 2000Å | | | | |

where
Bₛ = magnetic moment (saturation induction),
H_{c} = coercivity, and
Hₖ = magnetic anisotropy

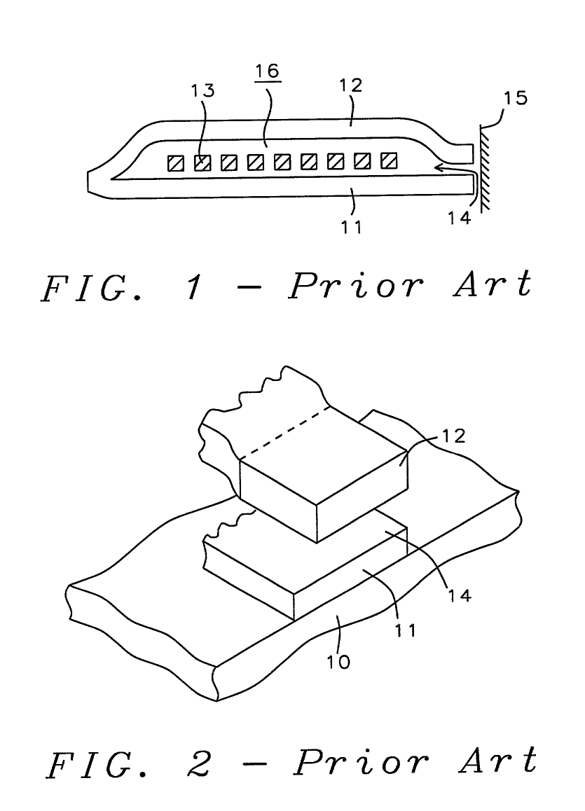

As indicated above, the present invention modifies the structure of prior art write heads, such as that illustrated in FIG. 2, by introducing an additional laminate, made up of two layers, between the various substructures that make up a write head. The laminate in question is a high magnetic moment layer on a soft magnetic or non-magnetic layer, the effect being for the laminate to have higher magnetic moment and lower coercivity than either layer taken alone.

Specifically, the layer of soft or non-magnetic material is between about 20 and 100 Angstroms thick while the layer of high moment material is between about 1,000 and 3,000 Angstroms thick.

The layer of non-magnetic material has a chemical composition of the form FeXY, where X represents any of the elements Al, Ti, Cr, Ta, Mo, or Rh and Y represents nitrogen or oxygen or both. Alternatively, X may represent Niₓ(Fe_{100-y}Co_{y}), with x being less than 10 and y being between 20 and 65. For the film to be nonmagnetic Y's concentration must be greater than about 20 atomic percent.

The layer of high moment magnetic material has a chemical composition of the form FeXY, where X represents any of the elements Al, Ti, Cr, Ta, Mo, or Rh and Y represents nitrogen or oxygen or both. Alternatively, X may represent Niₓ(Fe_{100-y}Co_{y}), with x being less than 10 and y being between 20 and 65. For the film to be magnetic Y's concentration must be less than about 20 atomic percent.

The process for forming the laminate is as follows:

Both layers of the laminate are deposited by means of sputtering to the thickness levels described above, nitrogen being included in the composition of the deposited films through reactive sputtering, i.e. nitrogen gas is mixed in with the argon. The Ar/N₂ ratio can be controlled either through a careful premixed gas bottle with the right composition ratio, or it can be introduced through two separate channels with different gas flow rate. For the process of the present Invention nitrogen concentration ranged from about 5 to 20% atom of the sputtering gas. Thus, the two films that make up the laminate may deposited from a single target in a single pumpdown the transition form non-magnetic to soft magnetic being effected by a (rapid) change in the nitrogen content of the sputtering gas.

The sputtering power can vary from 500W to 10 kW. The sputtering pressure ranged from about 2 mT to about 15 mT.

Using the above process, the laminate was applied in a variety of ways at one or more of the interfaces between sub-components of the write head. We present below five embodiments of the invention, each with different arrangements of the laminate relative to the other parts of the write head. It will, however, be understood that other arrangements of the laminate could also be envisaged without departing from the spirit of the invention. Also, the term ‘seed layer’ appears in some of the embodiments presented below. These are layers of materials such as NiFe or CoNiFe which are used to reduce the lattice mismatch between a film and the surface onto which it is to be deposited.

### 1^{st} Embodiment

Referring now to FIG. 3, layers 31 and 32 of the laminate are situated between upper pole 12 and write gap layer 14 as well as between lower pole 11 and substrate 10.

### 2^{nd} Embodiment

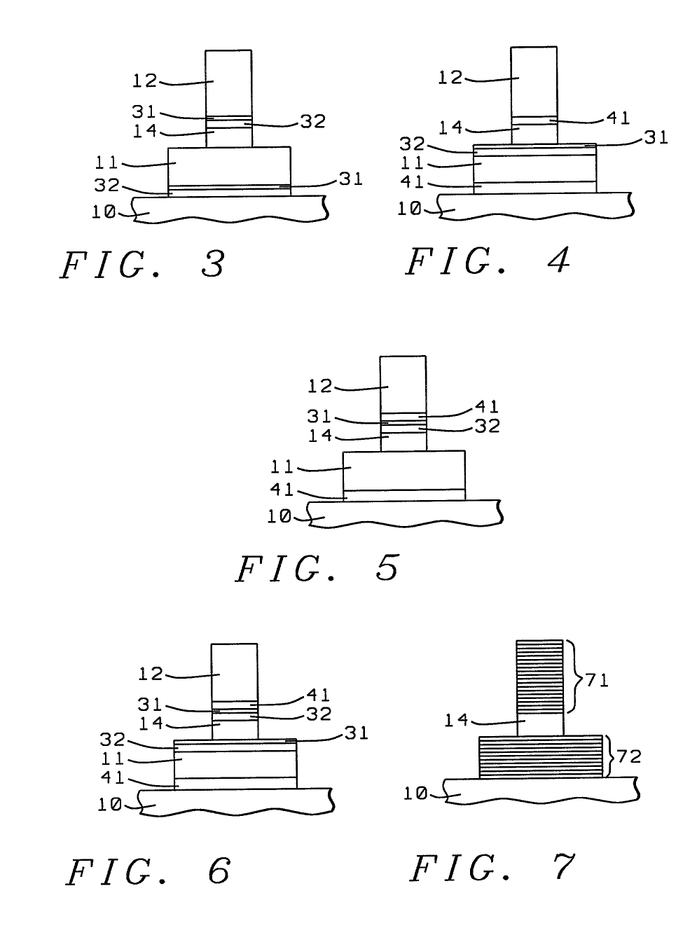

Referring now to FIG. 4, there are seed layers (41) between substrate 10 and lower magnetic pole 11 and also between the gap layer 14 and upper magnetic pole 12. Layers 31 and 32 of the laminate are situated between lower pole 11 and gap layer 14.

### 3^{rd} Embodiment

Referring now to FIG. 5, there is a seed layer 41 between substrate 10 and lower magnetic pole 11 as well as immediately below upper magnetic pole 12. Layers 31 and 32 of the laminate between gap layer 14 and the uppermost of the two seed layers.

### 4^{th} Embodiment

Referring now to FIG. 6, there is a seed layer between substrate 10 and lower magnetic pole 11. A second seed layer is located immediately below upper magnetic pole 12, as in the preceding embodiment. Unlike the preceding embodiment, however, layers 31 and 32 of the laminate contact both sides of gap layer 14.

### 5^{th} Embodiment

Referring now to FIG. 7, in this embodiment both the upper and the lower magnetic poles are formed exclusively from multiple instances of the laminate. Typically, between about 2 and 30 laminates would we used to build the upper pole 71 while between about 2 and 30 laminates would be used to build the lower pole 72. In addition to providing poles of both low coercivity and high magnetic moment, the option exists to give the non-magnetic layer of the laminate a very high resistivity (maximum nitrogen content) which, as noted earlier, will serve to greatly reduce the occurrence of eddy currents in the two poles.

What is claimed is:

1. A write head for a magnetic disk, comprising:
a lower magnetic pole on a substrate;
a non-magnetic gap layer on said lower magnetic pole;
an upper magnetic pole on the gap layer;
a laminate of a layer of high magnetic moment material on a seed layer, said laminate having a magnetic moment greater than about 22 kilogauss and a coercivity less than about 40 oersted; and
said write head further comprising:
the laminate being between the upper magnetic pole and the gap layer and
the laminate also being between the lower pole and the substrate.

2. The write head described in claim 1 wherein said seed layer is selected from the group consisting of non-magnetic materials and soft magnetic materials.

3. The write head described in claim 1 wherein said layer of high magnetic moment material is between about 1,000 and 3,000 Angstroms thick and said seed layer is between about 20 and 100 Angstroms thick.

4. The write head described in claim 2 wherein said seed layer of non-magnetic material has a chemical composition selected from the group consisting of FeXY and Ni_{b}(Fe₁₀₀₋ₐCoₐ)_{100-b}Y, where b<10 and 20<a<65;
with X representing an element selected from the group consisting of Al, Ti, Cr, Ta, Mo, and Rh;
with Y representing one or more elements selected from the group consisting of nitrogen and oxygen; and
with Y being present in said chemical composition at a concentration that is greater than about 20 atomic percent.

5. The write head described in claim 2 wherein said seed layer of soft magnetic material has a chemical composition of FeXY;
with X representing an element selected from the group consisting of Al, Ti, Cr, Ta, Mo, and Rh;
with Y representing one or more elements selected from the group consisting of nitrogen and oxygen; and
with Y being present in said FeXY composition at a concentration that is less than about 20 atomic percent.

6. The write head described in claim 1 wherein said high magnetic moment material has a chemical formula selected from the group consisting of FeXY and Ni_{b}(Fe₁₀₀₋ₐCoₐ)_{100-b}Y, where b<10 and 20<a<65;
with X representing an element selected from the group consisting of Al, Ti, Cr, Ta, Mo, and Rh;
with Y representing one or more elements selected from the group consisting of nitrogen and oxygen; and
with Y being present in said chemical composition at a concentration that is less than about 20 atomic percent.

7. A write head for a magnetic disk, comprising:
a lower magnetic pole on a substrate;
a non-magnetic gap layer on said lower magnetic pole;
an upper magnetic pole on the gap layer;
a laminate of a layer of a high magnetic moment material on a seed layer, said laminate having a magnetic moment greater than about 22 kilogauss and a coercivity less than about 40 oersted; and
said write head further comprising:
a seed layer between the substrate and the lower magnetic pole,
the laminate between the lower pole and the gap layer, and
the seed layer between the upper pole and the gap layer.

8. The write head described in claim 7 wherein said seed layer is selected from the group consisting of non-magnetic materials and soft magnetic materials.

9. The write head described in claim 8 wherein said seed layer of non-magnetic material has a chemical composition selected from the group consisting of FeXY and Ni_{b}(Fe₁₀₀₋ₐCoₐ)_{100-b}Y, where b<10 and 20<a<65;
with X representing an element selected from the group consisting of Al, Ti, Cr, Ta, Mo, and Rh;
with Y representing one or more elements selected from the group consisting of nitrogen and oxygen; and
with Y being present in said chemical composition at a concentration that is greater than about 20 atomic percent.

10. The write head described in claim 8 wherein said seed layer of soft magnetic material has a chemical composition of FeXY;
with X representing an element selected from the group consisting of Al, Ti, Cr, Ta, Mo, and Rh;
with Y representing one or more elements selected from the group consisting of nitrogen and oxygen; and
with Y being present in said FeXY composition at a concentration that is less than about 20 atomic percent.

11. The write head described in claim 7 wherein said high magnetic moment material has a chemical formula selected from the group consisting of FeXY and Ni_{b}(Fe₁₀₀₋ₐCoₐ)_{100-b}Y, where b<10 and 20<a<65;
with X representing an element selected from the group consisting of Al, Ti, Cr, Ta, Mo, and Rh;
with Y representing one or more elements selected from the group consisting of nitrogen and oxygen; and
with Y being present in said chemical composition at a concentration that is less than about 20 atomic percent.

12. A write head for a magnetic disk, comprising:
a lower magnetic pole on a substrate;
a non-magnetic gap layer on said lower magnetic pole;
an upper magnetic pole on the gap layer;
a laminate of a layer of a high magnetic moment material on a seed layer, said laminate having a magnetic moment greater than about 22 kilogauss and a coercivity less than about 40 oersted; and
said write head further comprising:
said seed layer between the substrate and the lower magnetic pole,
a non-magnetic gap layer on said lower pole,
said laminate on the gap layer, and
said seed layer between the laminate and the upper magnetic pole.

13. The write head described in claim 12 wherein said seed layer is selected from the group consisting of non-magnetic materials and soft magnetic materials.

14. The write head described in claim 13 wherein said seed layer of non-magnetic material has a chemical composition selected from the group consisting of FeXY and Ni_{b}(Fe₁₀₀₋ₐCoₐ)_{100-b}Y, where b<10 and 20<a<65;
with X representing an element selected from the group consisting of Al, Ti, Cr, Ta, Mo, and Rh;
with Y representing one or more elements selected from the group consisting of nitrogen and oxygen; and
with Y being present in said chemical composition at a concentration that is greater than about 20 atomic percent.

15. The write head described in claim 13 wherein said seed layer of soft magnetic material has a chemical composition of FeXY;
with X representing an element selected from the group consisting of Al, Ti, Cr, Ta, Mo, and Rh;
with Y representing one or more elements selected from the group consisting of nitrogen and oxygen; and
with Y being present in said FeXY composition at a concentration that is less than about 20 atomic percent.

16. The write head described in claim 12 wherein said high magnetic moment material has a chemical formula selected from the group consisting of FeXY and Ni_{b}(Fe_{100 -a}Coₐ)_{100-b}Y, where b<10 and 20<a<65;
with X representing an element selected from the group consisting of Al, Ti, Cr, Ta, Mo, and Rh;
with Y representing one or more elements selected from the group consisting of nitrogen and oxygen; and
with Y being present in said chemical composition at a concentration that is less than about 20 atomic percent.

17. A write head for a magnetic disk, comprising:
a lower magnetic pole on a substrate;
a non-magnetic gap layer on said lower magnetic pole;
an upper magnetic pole on the gap layer;
a laminate of a layer of a high magnetic moment material on a seed layer, said laminate having a magnetic moment greater than about 22 kilogauss and a coercivity less than about 40 oersted; and
said write head further comprising:
said seed layer between the substrate and the lower magnetic pole,
a first instance of the laminate between the lower pole and the gap layer,
a second instance of the laminate between the upper pole and the gap layer,
and
said seed layer between the upper pole and said second laminate.

18. The write head described in claim 17 wherein said seed layer is selected from the group consisting of non-magnetic materials and soft magnetic materials.

19. The write head described in claim 18 wherein said seed layer of non-magnetic material has a chemical composition selected from the group consisting of FeXY and Ni_{b}(Fe₁₀₀₋ₐCoₐ)_{100-b}Y, where b<10 and 20<a<65;
with X representing an element selected from the group consisting of Al, Ti, Cr, Ta, Mo, and Rh;
with Y representing one or more elements selected from the group consisting of nitrogen and oxygen; and
with Y being present in said chemical composition at a concentration that is greater than about 20 atomic percent.

20. The write head described in claim 18 wherein said seed layer of soft magnetic material has a chemical composition of FeXY;
with X representing an element selected from the group consisting of Al, Ti, Cr, Ta, Mo, and Rh;
with Y representing one or more elements selected from the group consisting of nitrogen and oxygen; and
with Y being present in said FeXY composition at a concentration that is less than about 20 atomic percent.

21. The write head described in claim 17 wherein said high magnetic moment material has a chemical formula selected from the group consisting of FeXY and Ni_{b}(Fe₁₀₀₋ₐCoₐ)_{100-b}Y, where b<10 and 20<a<65;
with X representing an element selected from the group consisting of Al, Ti, Cr, Ta, Mo, and Rh;
with Y representing one or more elements selected from the group consisting of nitrogen and oxygen; and
with Y being present in said chemical composition at a concentration that is less than about 20 atomic percent.

22. A write head for a magnetic disk, comprising:
laminates of a layer of a high magnetic moment material on a seed layer, each such laminate having a magnetic moment greater than about 22 kilogauss and a coercivity less than about 40 oersted;
on a substrate, a lower magnetic pole formed of a plurality of the laminates;
a non-magnetic gap layer on said tower magnetic pole; and
on the non-magnetic layer, an upper magnetic pole formed of a plurality of the laminates.

23. The write head described in claim 22 wherein said seed layer is selected from the group consisting of non-magnetic materials and soft magnetic materials.

24. The write head described in claim 23 wherein said seed layer of non-magnetic material has a chemical composition selected from the group consisting of FeXY and Ni_{b}(Fe₁₀₀₋ₐCoₐ)_{100-b}Y, where b<10 and 20<a<65;
with X representing an element selected from the group consisting of Al, Ti, Cr, Ta, Mo, and Rh;
with Y representing one or more elements selected from the group consisting of nitrogen and oxygen; and
with Y being present in said chemical composition at a concentration that is greater than about 20 atomic percent.

25. The write head described in claim 23 wherein said seed layer of soft magnetic material has a chemical composition of FeXY;
with X representing an element selected from the group consisting of Al, Ti, Cr, Ta, Mo, and Rh;
with Y representing one or more elements selected from the group consisting of nitrogen and oxygen; and
with Y being present in said FeXY composition at a concentration that is less than about 20 atomic percent.

26. The write head described in claim 22 wherein said high magnetic moment material has a chemical formula selected from the group consisting of FeXY and Ni_{b}(Fe₁₀₀₋ₐCoₐ)_{100-b}Y, where b<10 and 20<a<65;
with X representing an element selected from the group consisting of Al, Ti, Cr, Ta, Mo, and Rh;
with Y representing one or more elements selected from the group consisting of nitrogen and oxygen; and
with Y being present in said chemical composition at a concentration that is less than about 20 atomic percent.

27. The write head described in claim 22 wherein the lower magnetic pole consists of between about 2 and 30 of said laminates.

28. The write head described in claim 22 wherein the upper magnetic pole consists of between about 2 and 30 of said laminates.

29. A process for manufacturing a magnetic write head, comprising:
providing a substrate, a lower magnetic pole, a non-magnetic gap layer and an upper magnetic pole; and
by means of sputtering in a mixture of argon and nitrogen, depositing a laminate of a layer of high magnetic moment material on a seed layer, said laminate having a magnetic moment greater than about 22 kilogauss and a coercivity less than about 40 oersted.

30. The process described in claim 29 wherein said seed layer is selected from the group consisting of non-magnetic materials and soft magnetic materials.

31. The process described in claim 30 wherein said seed layer of non-magnetic material has a chemical composition selected from the group consisting of FeXY and Ni_{b}(Fe₁₀₀₋ₐCoₐ)_{100-b}Y, where b<10 and 20<a<65;
with X representing an element selected from the group consisting of Al, Ti, Cr, Ta, Mo, and Rh;
with Y representing one or more elements selected from the group consisting of nitrogen and oxygen; and
with Y being present in said chemical composition at a concentration that is greater than about 20 atomic percent.

32. The process described in claim 30 wherein said seed layer of soft magnetic material has a chemical composition of FeXY;
with X representing an element selected from the group consisting of Al, Ti, Cr, Ta, Mo, and Rh;
with Y representing one or more elements selected from the group consisting of nitrogen and oxygen; and
with Y being present in said FeXY composition at a concentration that is less than about 20 atomic percent.

33. The process described in claim 29 wherein said high magnetic moment material has a chemical formula selected from the group consisting of FeXY and Ni_{b}(Fe₁₀₀₋ₐCoₐ)_{100-b}Y, where b<10 and 20<a<65;
with X representing an element selected from the group consisting of Al, Ti, Cr, Ta, Mo, and Rh;
with Y representing one or more elements selected from the group consisting of nitrogen and oxygen; and
with Y being present in said chemical composition at a concentration that is less than about 20 atomic percent.

34. A process for manufacturing a magnetic pole for a magnetic write head, comprising:
by means of sputtering in a mixture of argon and nitrogen, depositing a number of two layer laminates, each such laminate consisting of a layer of a high magnetic moment material on a seed layer and having a magnetic moment greater than about 22 kilogauss and a coercivity less than about 40 oersted.

35. The process of claim 34 wherein the number of laminates is between about 2 and 30.

36. The process described in claim 34 wherein said seed layer is selected from the group consisting of non-magnetic materials and soft magnetic materials.

37. The process described in claim 36 wherein said seed layer of non-magnetic material has a chemical composition selected from the group consisting of FeXY and Ni_{b}(Fe₁₀₀₋ₐCoₐ)_{100-b}Y, where b<10 and 20<a<65;
with X representing an element selected from the group consisting of Al, Ti, Cr, Ta, Mo, and Rh;
with Y representing one or more elements selected from the group consisting of nitrogen and oxygen; and
with Y being present in said chemical composition at a concentration that is greater than about 20 atomic percent.

38. The process described in claim 36 wherein said seed layer of soft magnetic material has a chemical composition of FeXY;
with X representing an element selected from the group consisting of Al, Ti, Cr, Ta, Mo, and Rh;
with Y representing one or more elements selected from the group consisting of nitrogen and oxygen; and
with Y being present in said FeXY composition at a concentration that is less than about 20 atomic percent.

39. The process described in claim 34 wherein said high magnetic moment material has a chemical formula selected from the group consisting of FeXY and Ni_{b}(Fe₁₀₀₋ₐCoₐ)_{100-b}Y, where b<10 and 20<a<65;
with X representing an element selected from the group consisting of Al, Ti, Cr, Ta, Mo, and Rh;
with Y representing one or more elements selected from the group consisting of nitrogen and oxygen; and
with Y being present in said chemical composition at a concentration that is less than about 20 atomic percent.

40. The process of claim 34 wherein the non-magnetic layer has high electrical resistivity, whereby eddy current formation in said magnetic pole will be reduced.
